(19) United States
(12) Patent Application Publication
(10) Pub. No.: US 2008/0224109 A1
(43) Pub. Date: Sep. 18, 2008

(54) PULLER DEVICE

(76) Inventor: Wen-Cheng Hong, Minhsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/687,433

(22) Filed: Mar. 16, 2007

(51) Int. Cl. B62B 3/06

(52) U.S. Cl. 254/2 C

(57) ABSTRACT

A puller device has a body including a pulling assembly, a support set and a brace assembly pivotally coupled above the support set. The pulling assembly includes a cylinder affixed at one acting end thereof and hooks connected onto the cylinder. The pulling assembly is secured onto a movable bracket having a bulge extended downwardly therefrom. The hooks may be driven to expandably and retractably pull mechanical components out by a hydraulic control valve assembly. The support set may expand upwardly and retract downwardly for supporting the body to vertically move. The top of the support set is axially connected with the brace assembly, so as to support the combined movable bracket and pulling assembly as a whole. A micro-adjusting means is disposed onto the brace assembly for adjusting the lateral position of the body, and another micro-adjusting means is also mounted onto the brace assembly for vertically adjusting the tilted angle of the body.

### BACKGROUND OF THE INVENTION

1. Field of the Invention

The present invention relates to a puller device that allows to disassemble large-size mechanical components, e.g., bearings, gears, tubular members and the like, by using two micro-adjusting means to adjust the lateral position and the vertically tilted angle of the body thereof.

2. Description of the Prior Arts

Referring to FIG. 11, U.S. Pat. No. 5,419,027 issued on May 30, 1995, to Thomas J. et al., 1 discloses a prior art puller including a double acting cylinder 100 for driving hooks having clamping jaws 50 disposed thereon and links 70 pivotally connected to the clamping jaws 50 to disassemble large-size mechanical components. However, such a prior art puller can not be effectively adjusted its lateral and vertical position or angle for precisely disassembling the mechanical components.

The present invention has arisen to mitigate and/or obviate the afore-described disadvantages.

### SUMMARY OF THE INVENTION

The primary objective of the present invention is to provide a puller device, which allows to disassemble large-size mechanical components, e.g., bearings, gears, tubular members and the like, by using two micro-adjusting means to adjust the lateral position and the vertically tilted angle of the body thereof.

The puller device comprises a body including a pulling assembly, a support set, a brace assembly pivotally coupled above the support set, wherein the pulling assembly includes a cylinder affixed at one acting end thereof, and includes a plurality of hooks connected onto the cylinder, the pulling assembly is secured onto a movable bracket which includes a bulge extended downwardly therefrom, furthermore, the hooks may be driven to expandably and retractably pull mechanical components out by a hydraulic control valve assembly, the support set may expand upwardly and retract downwardly for supporting the body to vertically move, and at front section of the top of the support set is axially connected with the brace assembly, so as to support the combined movable bracket and pulling assembly as a whole, a micro-adjusting means having an adjustable bolt arranged therein is disposed onto the brace assembly for adjusting the lateral position of the body, and another micro-adjusting means is also mounted onto the brace assembly for vertically adjusting the tilted angle of the body, thereby allowing to disassemble large-size mechanical components, e.g., bearings, gears, tubular members and the like.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1A is a perspective diagram illustrating a support set of a body of a puller device of the present invention moving upwardly;

FIG. 1B is a sectional diagram illustrating a retracted state of a pulling assembly of the present invention;

FIG. 2 is perspective diagram illustrating the support set of the body of the puller device of the present invention moving downwardly;

FIG. 3 is a perspective diagram illustrating the pulling assembly of the body of the present invention being adjusted to tilt upwardly;

FIG. 4 is a perspective diagram illustrating the pulling assembly of the body of the present invention being adjusted to tilt downwardly;

FIG. 5 is a side diagram illustrating the pulling assembly of the body of the present invention being adjusted to move toward the left direction;

FIG. 6 is a cross sectional diagram illustrating a micro-adjusting means being utilized to adjustably control the pulling assembly to move toward the left direction;

FIG. 7 is a side diagram illustrating the pulling assembly of the body of the present invention being adjusted to move toward the right direction;

FIG. 8 is a cross sectional diagram illustrating the micro-adjusting means being utilized to adjustably control the pulling assembly to move toward the right direction;

FIG. 9 is a perspective diagram illustrating the assembly of the puller device of the present invention;

FIG. 10A is a perspective diagram illustrating the application of the puller device of the present invention;

FIG. 10B is a cross sectional diagram illustrating an expanded state of the pulling assembly of the present invention;

FIG. 11 is a cross sectional diagram of a prior art puller device of U.S. Pat. No. 5,419,027.

### DETAILED DESCRIPTION OF THE PREFERRED EMBODIMENT

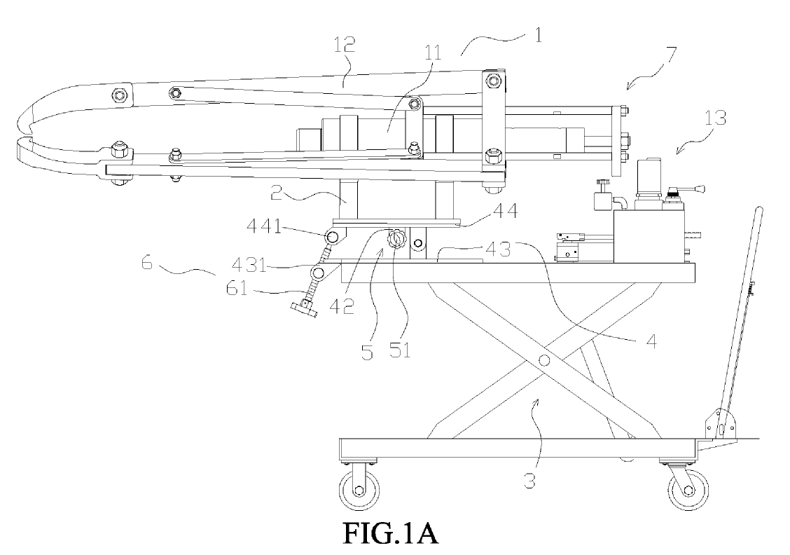

Referring to FIGS. 1A, 3 and 5, a puller device in accordance with the present invention comprises a body 7 including a pulling assembly 1, a support set 3, a brace assembly 4 pivotally coupled above the support set 3, a micro-adjusting means 5 having an adjustable bolt 51 arranged therein disposed onto the brace assembly 4 for adjusting the lateral position of the body 7, and another micro-adjusting means 6 also mounted onto the brace assembly 4 for vertically adjusting the tilted angle of the body 7, thereby allowing to disassemble large-size mechanical components, e.g., bearings, gears, tubular members and the like.

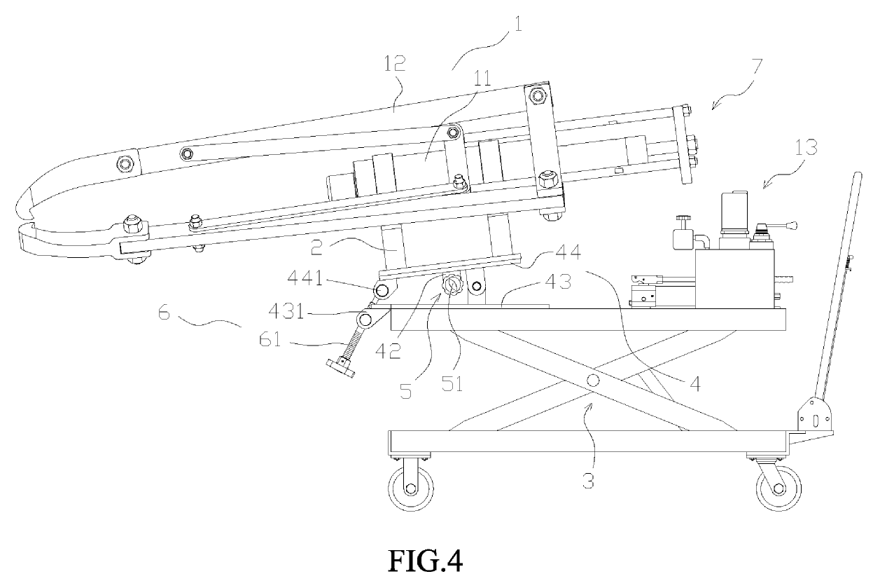

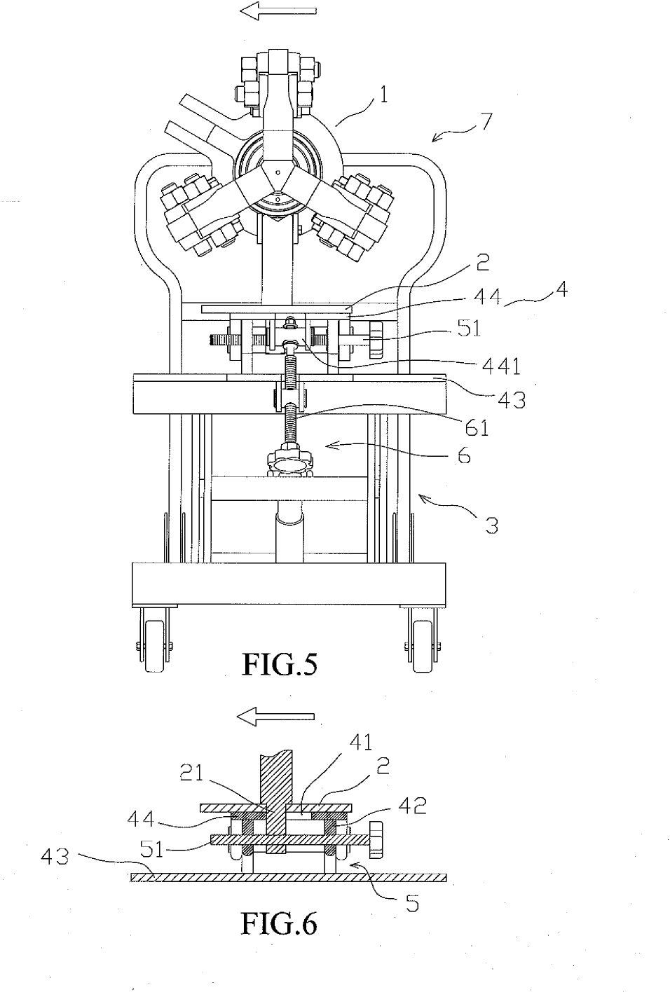

Referring to FIG. 1A, the pulling assembly 1 includes a cylinder 11 affixed at one acting end thereof, and includes a plurality of hooks 12 connected onto the cylinder 11 (as shown in FIG. 1B). The pulling assembly 1 is secured onto a movable bracket 2 (as illustrated in FIG. 5), and the movable bracket 2 includes a bulge 21 extended downwardly therefrom (as shown in FIG. 6). Furthermore, the hooks 12 may be driven to expandably and retractably pull mechanical components out by a hydraulic control valve assembly 13.

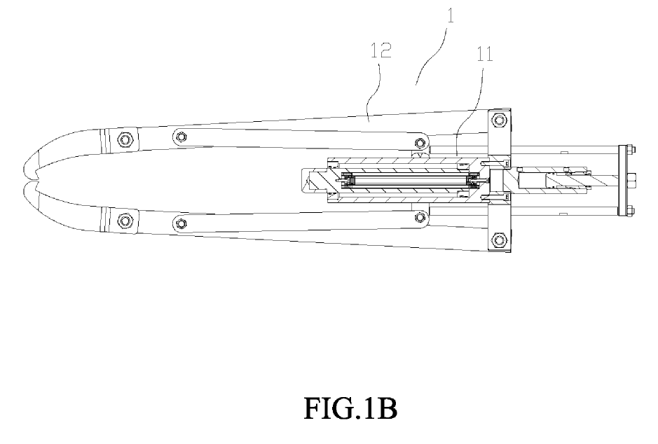

With reference to FIGS. 1A, 2 and 5, the support set 3 may expand upwardly (as shown in FIG. 1A) and retract downwardly (as shown in FIG. 2) for supporting the body 7 to vertically move, and at front section of the top of the support set 3 is axially connected with the brace assembly 4, so as to support the combined movable bracket 2 and pulling assembly 1 as a whole.

As illustrated in FIGS. 5 and 6, the brace assembly 4 includes a bore 41 formed therein for fitting the bulge 21 of the movable bracket 2, such that the micro-adjusting means 5 permits to pass the bulge 21 through the brace assembly 4. The brace assembly 4 includes a supporting member 42 fixed therein for cooperating with the adjustable bolt 51 of the micro-adjusting means 5 which passes through the supporting member 42 and the bulge 21, such that the micro-adjusting means 5 may adjustably control the pulling assembly 1 supported on the movable bracket 2 to laterally move.

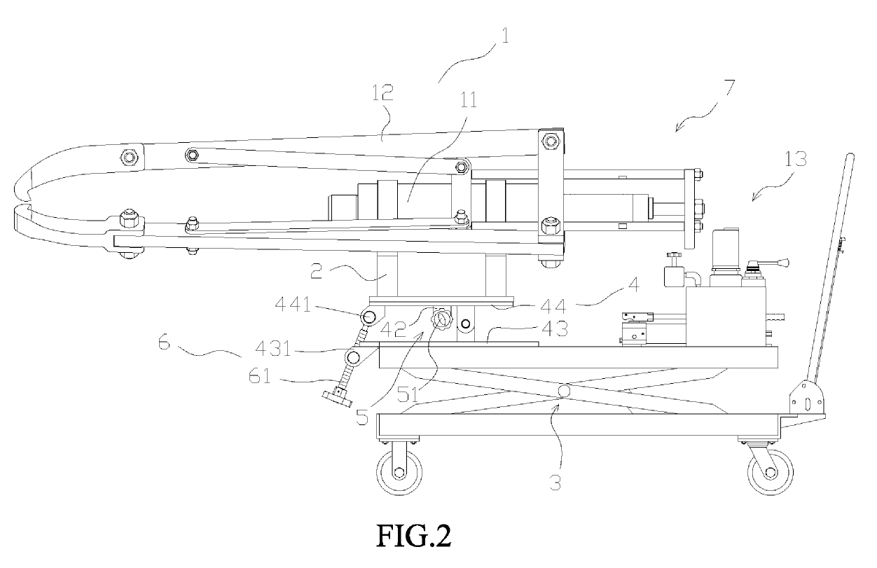

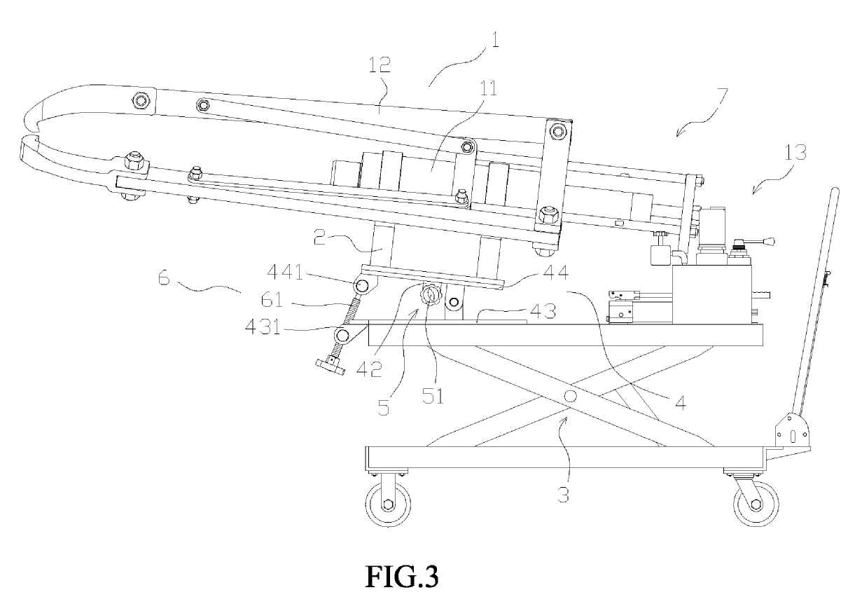

As illustrated in FIGS. 3 and 5, a micro-adjusting means 6 includes an adjustable bolt 61 arranged therein, a plate member 43 is formed on the bottom of the brace assembly 4 and includes a fastening part 431 disposed on the bottom thereof, and a deck member 44 is formed on the top of the brace assembly 4 and includes a fastening part 441 mounted on the bottom thereof, such that the adjustable bolt 61 may engageably pass through the fastening parts 431 and 441 so that the micro-adjusting means 6 may be controlled to adjust the vertically tilted angle of the pulling assembly 1 (as shown in FIGS. 3 and 4).

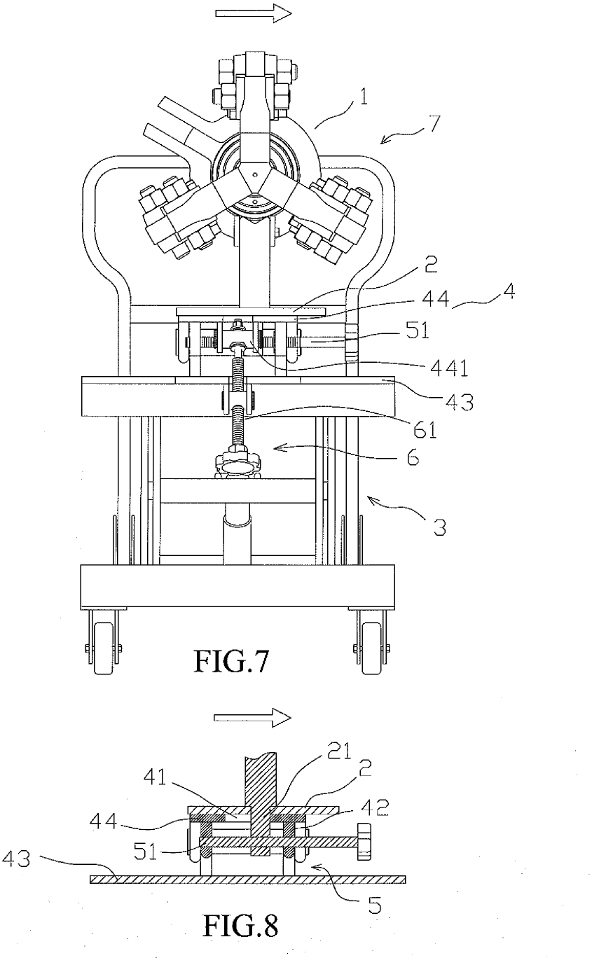

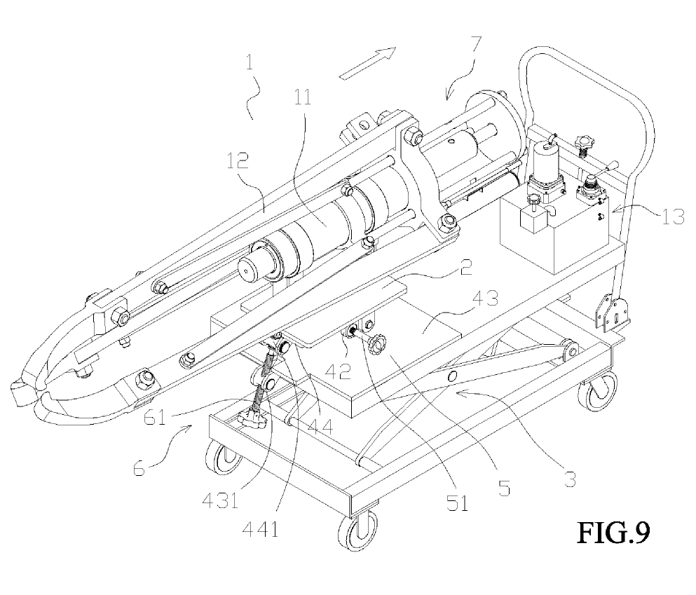

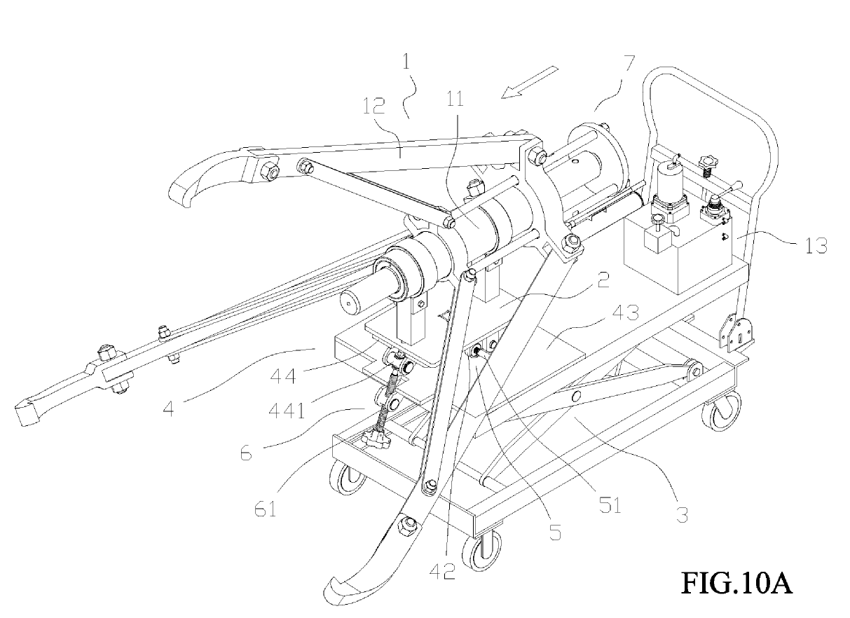

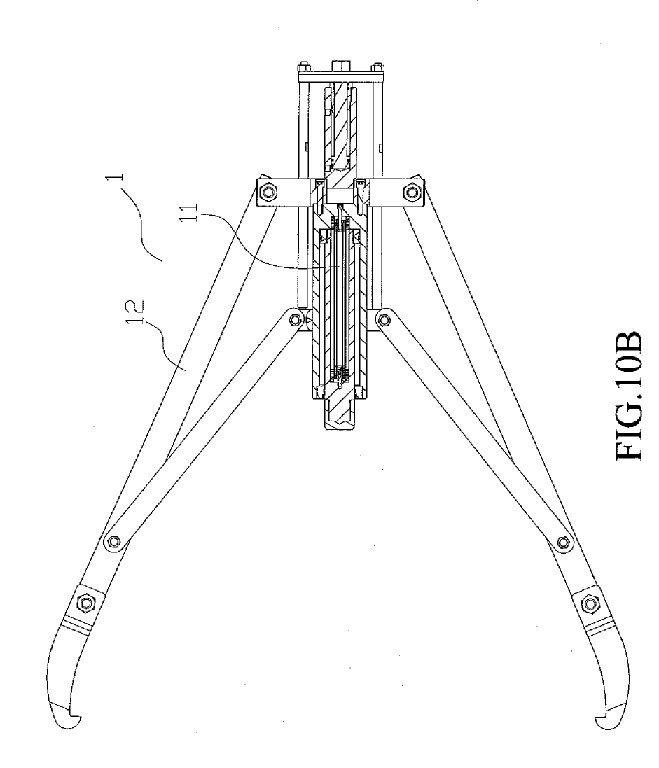

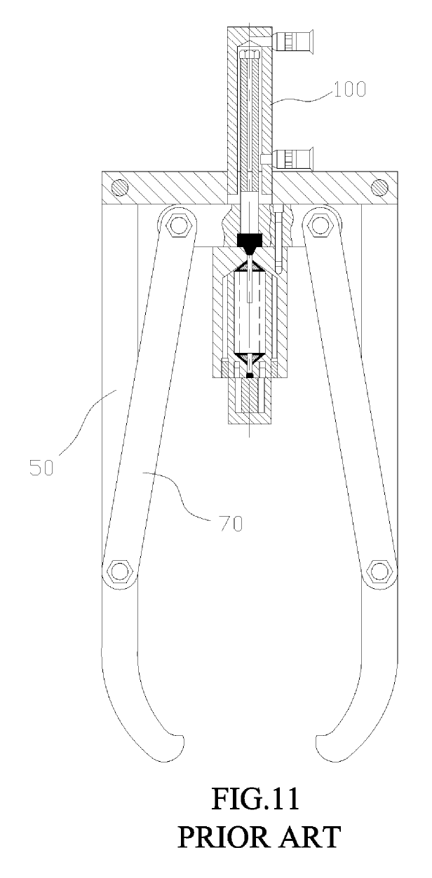

In the operation of the micro-adjusting means 5 (as illustrated in FIGS. 5-8), by rotating the adjustable bolt 51 inwardly or outwardly, the body 7 may be laterally moved. For example, as shown in FIGS. 5-6, the body 7 is moved toward the left direction, yet as illustrated in FIGS. 7-8, the body 7 is moved toward the right direction. Moreover, in the operation of the micro-adjusting means 6 (as shown in FIGS. 3 and 4), by rotating the adjustable bolt 61 upwardly or downwardly, the tilted angle of the body 7 may be vertically adjusted. For example, as shown in FIG. 3, the tilted angle of the body 7 is adjusted upwardly, yet as illustrated in FIG. 4, the tilted angle of the body 7 is adjusted downwardly. As can be seen in FIG. 9, the micro-adjusting means 5 and 6 may be utilized to adjust the body 7 to the desired direction and angle based on practical use requirement so as to disassemble large-size mechanical components (as shown in FIGS. 10A and 10B).

While we have shown and described various embodiments in accordance with the present invention, it should be clear to those skilled in the art that further embodiments may be made without departing from the scope of the present invention.

1. A puller device comprising:
a body;
including a pulling assembly;
a support set;
a brace assembly pivotally coupled above said support set, wherein said pulling assembly includes a cylinder affixed at one acting end thereof, wherein said pulling assembly includes a plurality of hooks connected onto said cylinder;
a movable bracket including a bulge extended downwardly therefrom, with the pulling assembly secured to the moveable bracket;
a hydraulic control assembly, with said plurality of hooks driven to expandably and retractably pull mechanical components out by the hydraulic control valve assembly, wherein said support set is expandable upwardly and retractable downwardly for supporting said body to vertically move, and wherein said support set is axially connected with said brace assembly to support the movable bracket and pulling assembly;
a micro-adjusting means having an adjustable bolt arranged therein, with the micro-adjusting means disposed onto said brace assembly for adjusting a lateral position of said body; and
another micro-adjusting means mounted onto said brace assembly for vertically adjusting a tilted angle of said body, thereby allowing to disassemble large-size mechanical components.

2. The puller device as claimed in claim 1, wherein said brace assembly includes a bore formed therein for fitting said bulge of said movable bracket, wherein said bulge passes through the bore of said brace assembly, and said brace assembly includes a supporting member fixed therein for cooperating with an adjustable bolt of said micro-adjusting means which passes through said supporting member and said bulge, wherein said micro-adjusting means adjustably controls said pulling assembly supported on said movable bracket to laterally move.

3. The puller device as claimed in claim 1, wherein said other micro-adjusting means includes an adjustable bolt arranged therein, a plate member is formed on said brace assembly and includes a fastening part disposed thereon and a deck member is formed on said brace assembly and includes a fastening part mounted on the bottom thereon, wherein said adjustable bolt engageably passes through said fastening parts of said plate member and said deck member, wherein said other micro-adjusting means controllably adjusts the tilted angle of said pulling assembly.

4. The puller device as claimed in claim 1, wherein said support set is moveable upwardly or downwardly based on practical use requirement.

5. The puller device as claimed in claim 2, wherein said other micro-adjusting means includes an adjustable bolt arranged therein, a plate member is formed on said brace assembly and includes a fastening part disposed thereon, and a deck member is formed on said brace assembly and includes a fastening part mounted thereon., wherein said adjustable bolt engageably passes through said fastening parts of said plate member and said deck member, wherein said other micro-adjusting means controllably adjusts the tilted angle of said pulling assembly.

6. The puller device as claimed in claim 5, wherein the moveable bracket is slideable upon the plate member, with the bore formed in the plate member, with the plate member intermediate the moveable bracket and the deck member.
